(19) United States
(12) Patent Application Publication
(10) Pub. No.: US 2007/0006076 A1
(43) Pub. Date: Jan. 4, 2007

(54) System and method for providing Asian Web font documents

(75) Inventor: Kuo-Young Cheng, Taichung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: DynaComware Taiwan Inc.

(21) Appl. No.: 11/388,715

(22) Filed: Mar. 24, 2006

(30) Foreign Application Priority Data
Jun. 30, 2005 (JP) 2005-192393

(51) Int. Cl. G06F 17/00

(52) U.S. Cl. 715/542; 715/530

(57) ABSTRACT

A system and method are provided for browsing Web page documents containing Asian characters with multiple font faces which were not recognizable by a browser in the prior art. The system and method permit a computer user to view the Web page documents containing Asian characters in their original (and intended) form and appearance. A Web font server receives an Asian Web page document from a Web server and converts it to a Web font document that can be recognized and properly displayed by a Web font browser of the present invention.

### FIELD OF THE INVENTION

The present invention relates to the art of Asian character processing and, more particularly, to a system and method for browsing Asian character documents including multiple font faces.

### BACKGROUND

Web information available on the Internet is displayed on a client system via a Web browser operating on the client system. Typically, a client computer user accesses Web information by directly entering a URL (Uniform Resource Locator) of a desired Web page into the browser, or by using a search engine to locate several Web pages of interest and selecting one of them, or by moving and clicking a mouse on a hyperlink to the URL displayed on a screen. The browser will then download a Web page from the specified URL and display the Web page on the computer screen.

A Web page, or an electronic document available on the World Wide Web forming part of the Internet, is in hypertext markup language (HTML) format. The World Wide Web consists of numerous computer servers (or Web servers, or “sites”) on the Internet, where each Web server stores HTML documents that can be accessed by client computers on the Internet.

A HTML document generally includes text, HTML tags that specify formatting and appearance of the document, links (or hyperlinks) to related HTML documents, and other files that may contain, for example, sound, image, video, etc. For example, HTML tags may specify a particular font in which text in the document is to be displayed. A font is a collection of characters and symbols that share a common design. In general, a font has three design elements: font face, style, and size. The font face of a font refers to specific visual characteristics of characters and symbols in the font such as the width or curve of strokes that form a character. Style refers to the weight (e.g., in bold) and slant (e.g., in italic) of a font. Size generally refers to the height of the characters in a font.

When a Web browser retrieves a HTML document, it interprets the document, in particular its HTML tags, to identify a font face, style, and size with which characters in the document are to be displayed. A client computer on which the browser is operating, however, can support and display a particular font face only if that font face is registered or installed in the client computer. While many standard font faces are registered in many client computers, other non-standard (or unique) font faces are not, and also, the font faces that are registered at different client computers vary widely. Thus, if a particular font face designated in a HTML document is not supported by a client computer receiving the HTML document, the client computer cannot display the document with the original font face.

Typically, when a client computer does not support a font face designated in a HTML document, the browser operating thereon selects a default font face and replaces the designated font face with the default font face. This is undesirable as it causes the appearance of a Web page to differ from what was intended by its author. This problem is more serious with Asian language Web pages because there are more variations and types of font faces in Asian languages than in Roman-based languages. As a result, text often looks distorted or difficult to read in Asian language Web pages. Also, because Asian characters generally consist of ideographical symbols, each having a specific meaning, even a slight modification of a font face may cause the intent of the Web page author to be lost or misinterpreted.

FIG. 1 illustrates a prior art system for browsing an Asian language Web page. The system includes a Web server 21 and a client computer 13, both connected to the Internet 22. The Web server 21 supports an Asian language Web page 32, including three Chinese characters 10, 11, and 12, in three different font faces, respectively. The client computer 13 includes a display device 36 and an input device 25, and also includes a browser program 28 operating thereon.

Suppose that all of the three font faces, in which the three Chinese characters 10, 11, and 12 are defined, are not supported by the client computer 13. Generally, display of an Asian font on a computer screen is based on a font face and a character code. A character code, typically an alpha-numeric code, is assigned to each character within a font. Examples of character code sets include JIS code, Shift JIS code, Unicode, and ECU code. When a client computer receives a Web page document including Asian characters, each character is associated with a character code and a font face. In the present example of FIG. 1, suppose further that the character codes for the first and third Chinese characters 10 and 12 are supported (i.e., standard character codes), but the character code for the second Chinese character 11 is not part of any standard character code set and thus is not supported (or recognizable) by the client computer 13. As a result, as illustrated, the client computer 13 renders the first and third Chinese characters 10 and 12 in the original Asian language Web page 32 as Chinese characters 16 and 18, respectively, in a font face that is substantially different from the font faces of the original characters 10 and 12. This is because the client computer 13 does not support either of the font face of the first original character 10 or the font face of the third original character 12, and thus the browser program 28 has replaced these unsupported font faces with its default font face. In this example, the client computer 13 at least recognized the character codes for the first and third Chinese characters 10 and 12, and therefore was able to display the same characters, albeit in a different font face. As for the second Chinese character 11 in the original Web page 32, however, the client computer 13 did not even recognize its character code, let alone its font face, and accordingly, the client computer 13 could not display the second original character 11 at all. Thus, the second Chinese character 11 in the original Web page 32 is simply missing in the Web page, as displayed on the client computer 13.

In short, because the browser program 28 only recognizes a standard character code and an installed font face, some of the characters in the original Asian language Web page 32 may be distorted (such as the first and third Chinese characters 10 and 12), or may be deleted (such as the second Chinese character 11) in the Web page, as displayed on the client computer 13.

A need exists for a system and method that permits users of client computers to browse and view Asian language Web pages, in particular Web pages including multiple font faces, in their original appearance.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present invention, a network-based method is provided for constructing a Web font document based on an Asian Web page document. The method includes generally five steps: (1) receiving an Asian Web page document in a HTML file from a Web server; (2) extracting font data from the received Asian Web page document, wherein the font data include a character code and a name of a font face for each character included in the Asian Web page document; (3) replacing each character in the received Asian Web page document with a Web font character, wherein the Web font character is defined by a character code, a name of a Web font face, and a Uniform Resource Locator (URL) of the Web font face on a network; (4) creating a Web font document in a HTML file; and (5) sending the created Web font document to the Web server to replace the Asian Web page document at the Web server with the created Web font document.

In accordance with one aspect of the invention, a Web font document in a HTML file includes a header portion and a body portion. The header portion includes the name of a Web font face and the URL of the Web font face for each character, and the body portion includes the character code for each character.

In accordance with another aspect of the invention, step (3) of replacing each character in the received Asian Web page document with a Web font character may involve searching for a predefined Web font character in a database based on a character code and a name of a font face of the character to be replaced in the received Asian Web page document. Additionally, or alternatively, step (3) may involve generating a new Web font character based on an image of the character to be replaced in the received Asian Web page document.

In accordance with another embodiment of the present invention, a network-based system is provided for constructing a Web font document based on an Asian Web page document supported by a Web server. The system includes generally three elements: (a) a Web server connected to a network and supporting an Asian Web page document; (b) a Web font server connected to the network for constructing a Web font document based on an Asian Web page document received from a Web server; and (c) a non-standard Web font server connected to the network. The Web font server further includes a Web font database that includes standard Web font characters, and the non-standard Web font server further includes a non-standard Web font database that includes non-standard Web font characters.

In accordance with one aspect of the invention, the Web font server still further includes five sub-elements: (i) means for receiving an Asian Web page document in a HTML file from a Web server; (ii) means for extracting font data from the received Asian Web page document, wherein the font data include a character code and a name of a font face for each character included in the Asian Web page document; (iii) means for replacing each character in the received Asian Web page document with a Web font character, wherein the Web font character is defined by a character code, a name of a Web font face, and a Uniform Resource Locator (URL) of the Web font face on a network; (iv) means for creating a Web font document in a HTML file; and (v) means for sending the created Web font document to the Web server to replace the Asian Web page document at the Web server with the created Web font document.

In accordance with another aspect of the present invention, the means for replacing each character in the received Asian Web page document with a Web font character first search for a predefined Web font character in the Web font database based on a character code and a name of a font face of the character to be replaced in the received Asian Web page document. If no corresponding predefined Web font character is found, the means further search for a corresponding predefined Web font character in the non-standard Web font database.

In accordance with still another aspect of the present invention, the means for replacing each character in the received Asian Web page document with a Web font character further include means for instructing the non-standard Web font server to generate a new Web font character based on an image of the character to be replaced in the received Asian Web page document. For example, a new Web font character may be generated in terms of explicit parameters, such as key points and width values, and implicit parameters that are defined based on the explicit parameters, such as feature points and curve ratios, which together describe a shape of the received image of the character.

In accordance with a further embodiment of the present invention, a method is provided for defining Web font characters for replacing characters included in an Asian Web page document. The method defines standard Web font characters in the following three steps: (i) designating a font face name to a set of standard Asian characters, each associated with a standard character code; (ii) defining the set of standard Asian characters as standard Web font characters based on their font face name as designated in sub-step (i), standard character codes, and a Uniform Resource Locator (URL) of the Web font characters; and (iii) storing the standard Web font characters in a file in a database. The method further defines non-standard Web font characters in the following five steps: (i) receiving an image of a character to be defined as a non-standard Web font character; (ii) generating a non-standard Web font character based on the received image of the character; (iii) assigning a font face name and a character code to the non-standard Web font character generated in sub-step (ii) above; (iv) defining the non-standard Web font character in terms of its font face name, character code, and a URL of the Web font character; and (v) storing the non-standard Web font character in a file in a database.

In accordance with yet another embodiment of the present invention, a Web browser program is provided for browsing Asian Web font documents, including generally four means: (1) means for receiving a user request to view an Asian Web font document at a particular Uniform Resource Locator (URL); (2) means for receiving an Asian Web font document in a HTML file from a Web server corresponding to the particular URL; (3) means for decoding the received HTML file to identify the name of a Web font face, the URL of the Web font face, and the character code for each Web font character included in the Asian Web font document; and (4) means for displaying the Asian Web font document by rendering each Web font character according to the corresponding name of a Web font face, the URL of the Web font face, and the character code.

In accordance with still another embodiment of the present invention, a computer-readable tangible medium is provided, which includes computer-executable instructions for a Web font server to perform the following five steps: (a) receiving an Asian Web page document in a HTML file from a Web server; (b) extracting font data from the received Asian Web page document, wherein the font data include a character code and a name of a font face for each character included in the Asian Web page document; (c) replacing each character in the received Asian Web page document with a Web font character, wherein the Web font character is defined by a character code, a name of a Web font face, and a Uniform Resource Locator (URL) of the Web font face on a network; (d) creating a Web font document in a HTML file; and (e) sending the created Web font document to the Web server to replace the Asian Web page document at the Web server with the created Web font document.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a prior art system for browsing Asian language Web pages;

FIG. 2 illustrates an overall system for constructing a Web font document based on a Web page document, formed in accordance with one embodiment of the present invention;

FIG. 3A illustrates a sample Web page document in a HTML file, as received from a Web server and interpreted by a conventional browser;

FIG. 3B illustrates a sample Web font document in a HTML file, which is constructed based on a Web page document, in accordance with various exemplary embodiments of the present invention;

FIG. 3C illustrates a portion of the sample Web font document of FIG. 3B, which is produced during the construction of the sample Web font document of FIG. 3B;

FIG. 4 is a flowchart illustrating a process of constructing a Web font document, in accordance with one embodiment of the present invention;

FIG. 5 schematically illustrates various concepts used to generate a Web font character based on explicit and implicit parameters, in accordance with one embodiment of the present invention; and

FIG. 6 is a flowchart illustrating a process to be performed by a browser program operating in a client computer for browsing Web font documents, in accordance with various exemplary embodiments of the present invention.

### DETAILED DESCRIPTION

According to a method and system of the present invention, a Web browser operating on a client computer can display an Asian Web font document including multiple font faces in its original appearance. In various exemplary embodiments, the invention achieves this goal by replacing font data of a conventional Asian Web page document in a HTML file with “Web font” data that can be properly interpreted and displayed by a browser. Specifically, the invention provides a system and method of constructing a Web font document in a HTML file, based on a conventional Asian Web page document in a HTML file.

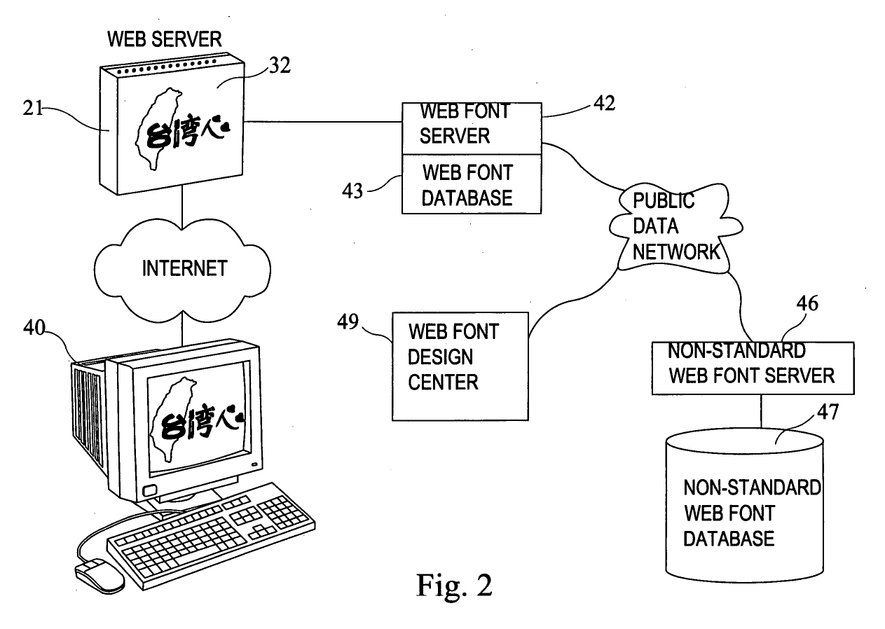

FIG. 2 illustrates an overall system for constructing a Web font document based on an Asian Web page document supported by a Web server, according to one embodiment of the present invention. The system includes a client computer 40 and a Web server 21 supporting an Asian language Web page 32, which are both connected to the Internet. The system further includes a Web font server 42 connected to the Internet, which performs the function of constructing a Web font document based on an Asian Web page document received from the Web server 21. The Web font server 42 includes or is coupled to a Web font database 43 storing standard Web font characters.

The Web font server 42 is connected to a non-standard Web font server 46 and a Web font design center computer 49, via a public (or private) data network. The non-standard Web font server 46 includes or is connected to a non-standard Web font database 47 storing non-standard Web font characters. Briefly, the non-standard Web font server 46, the non-standard Web font database 47, and the Web font design center computer 49 are provided to retrieve or create a non-standard Web font character and send it to the Web font server 42 if the Web font server 42 cannot find a desired Web font character in the Web font database 43 to create a Web font document.

In accordance with various exemplary embodiments of the present invention, the Web font server 46 performs generally five steps. First, it receives an Asian Web page document in a HTML file from a Web server. Second, it extracts font data from the received Asian Web page document, wherein the font data comprise a character code and a name of a font face for each character included in the Asian Web page document. Third, it replaces each character in the received Asian Web page document with a Web font character, wherein the Web font character is defined by a character code, a name of a Web font face, and a Uniform Resource Locator (URL) of the Web font face on a network (e.g., the Internet). Fourth, it creates a Web font document in a HTML file. Fifth, it sends the created Web font document to the Web server to replace the Asian Web page document at the Web server with the created Web font document.

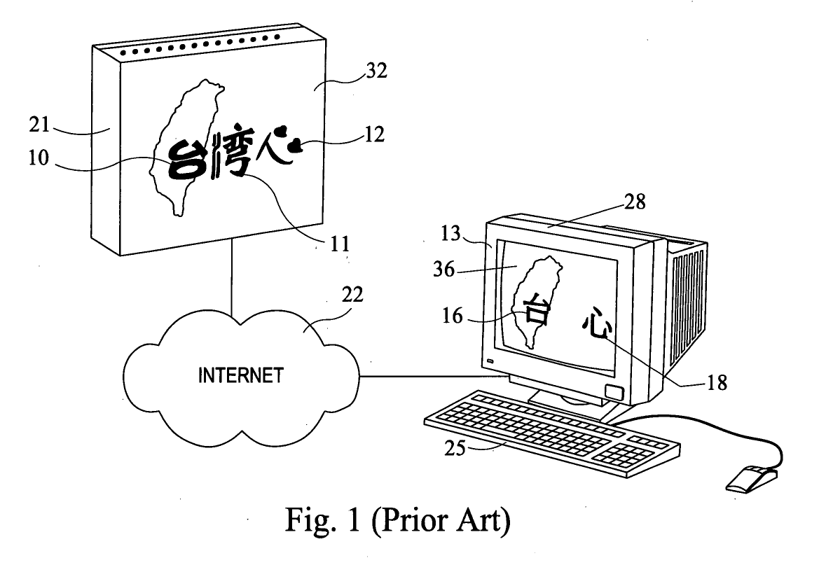

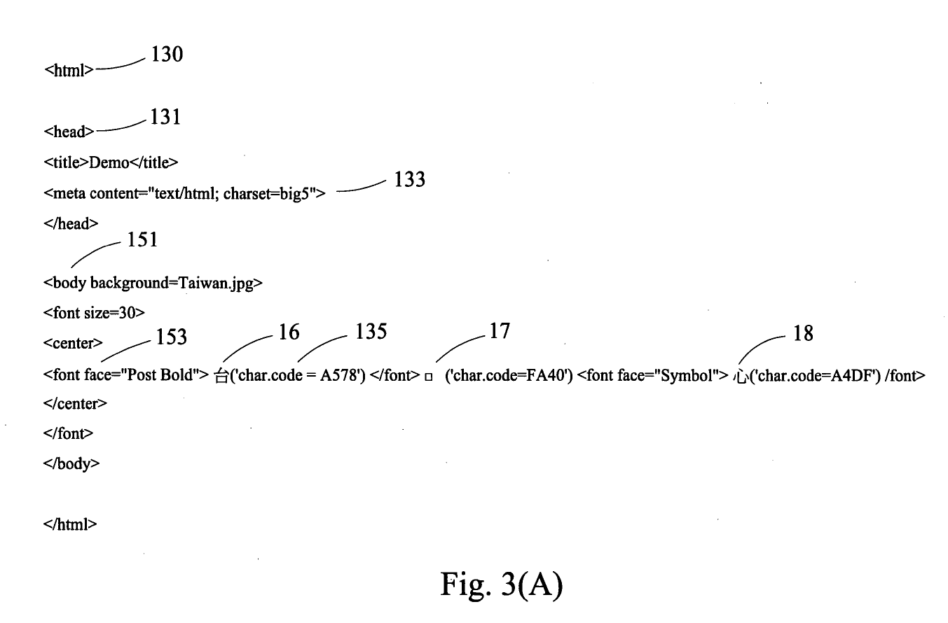

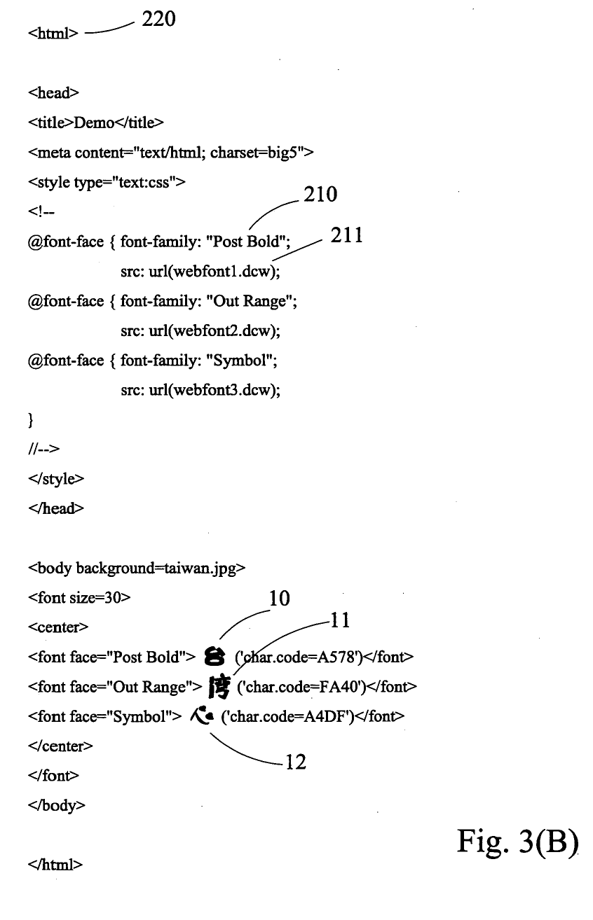

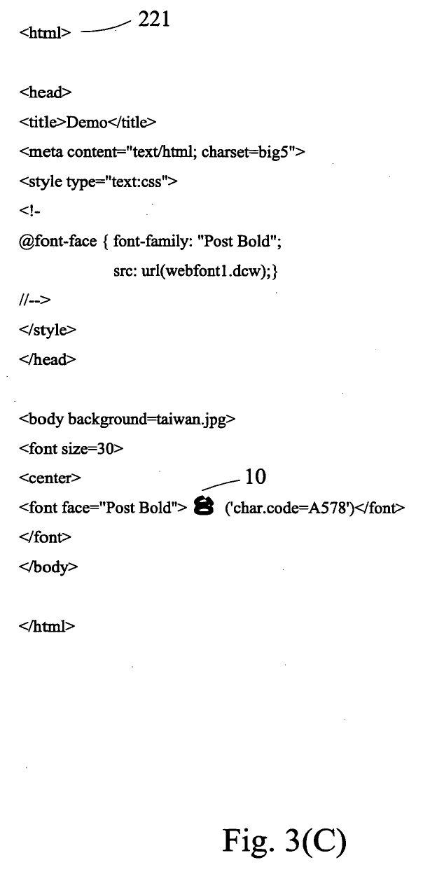

FIG. 3A is a sample Asian Web page document in a HTML file 130, corresponding to the Asian language Web page 32 shown in FIGS. 1 and 2, as received and processed by a conventional browser. The file's header portion (<head>) 131 designates a particular character code set “big5” 133 used in the Asian Web page document. (“big5” is a character code set widely used, for example, in Taiwan.) The HTML file's body portion 151 originally included font data (such as a character code and a font face name) for the three Chinese characters 10, 11, and 12 (see FIG. 1) used in the Asian language Web page 32. In the present example, the character codes (in “big5” character code set) for the three characters 10, 11, and 12 were “A578, “FA40,” and “A4DF” (see 135), while the font faces for the three characters were “Post Bold,” “Lishu” (not shown in the HTML file 130 of FIG. 3A because the character code “FA40” for the second Chinese character 12 was not recognized), and “Symbol” (see 153). Because the client computer on which the browser is operating does not recognize any of the three font faces or the character code for the second Chinese character 11, the browser has replaced the first and third original Chinese characters 10 and 12 with the characters 16 and 18 in its default font face, and further replaced the second original character 11 (whose character code was unrecognizable) with a blank 17, as shown on the display device 36 in FIG. 1.

FIG. 3B is a sample Asian Web font document in a HTML file, which the Web font server 42 has constructed based on the Asian Web page document corresponding to the Asian language Web page 32 of FIGS. 1 and 2. The HTML file 220 in the present example includes a header portion and a body portion, and the header portion includes a name of a Web font face 210 and a Uniform Resource Locator (URL) of the Web font face (or, more specifically, the Web font face file, such as “webfont1.dcsw”) 211 for each of the three Chinese characters 10, 11, and 12. Specifically, each of the font faces “Post Bold,” “Out Range (indicating a non-standard font face), and “Symbol,” and where these font faces can be found on the network, are listed in the header portion. Thus, even the Web font face for the second Chinese character, whose character code and font face were both unrecognizable in the original Asian Web page document, can now be accessed at the listed Web font face URL address for properly displaying the second character with the Web font face. The body portion of the HTML file 220 includes a character code (“A578,” “FA40,” “A4DF), and perhaps also the name of the font face, for each of the three Chinese characters 10, 11, and 12.

FIG. 3C is a sample Asian Web font document in a HTML file 221, which is under construction by the Web font server 42 interpreting the received Asian Web page document. Specifically, FIG. 3C shows that only the first Chinese character 10 in the received Asian Web page document has been processed, i.e., its original font data, including a character code and a font face name, have been replaced with Web font data, including a character code, Web font face name, and URL address of the Web font face.

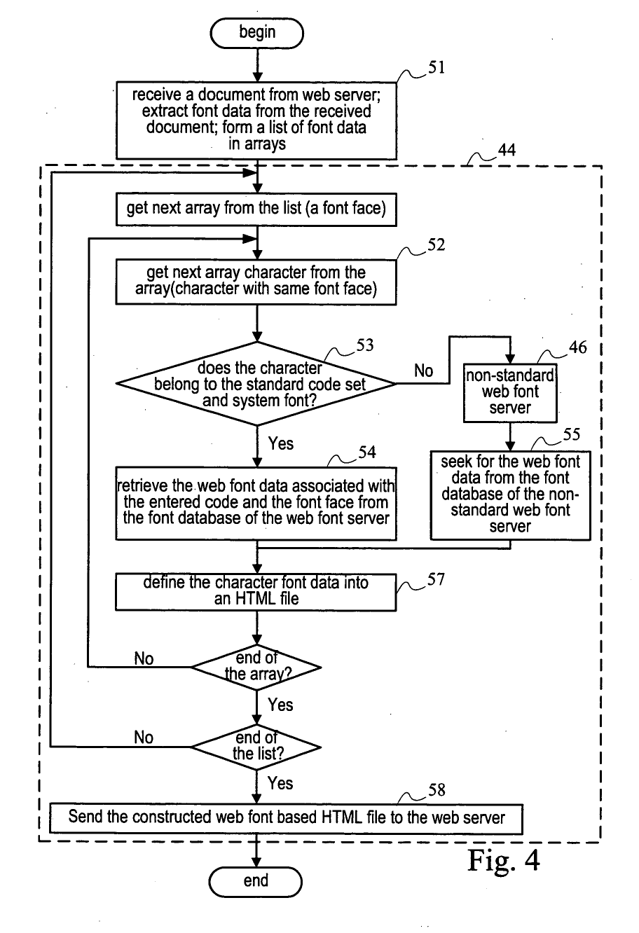

FIG. 4 is a flowchart illustrating a process to be performed by the Web font server 42 to construct a Web font document based on an Asian Web page document, in accordance with one embodiment of the present invention. At step 51, the Web font server 42 receives an Asian Web page document from a Web server. At this time, the Web font server 42 may determine whether the received document is already a Web font document by checking its format, and proceed to the following steps only if the received document is not a Web font document. Still at step 51, the Web font server 42 then extracts font data (e.g., character codes and font face names of the characters included in the document) from the received document. Then, the extracted font data are arranged in a series of arrays, where each array corresponds to a particular font face. For example, the arrays may be constructed as below.

| Font face | Character codes |
|---|---|
| “Post Bold” | A578, A948, A384, A948 . . . |
| “Out Range” | FA40, FA30, FA04, FA31 . . . |
| “Symbol” | A4DF, A3BI, A5BW, A9OP . . . |

A broken-line box 44 in FIG. 4 encloses various steps to be performed in constructing a Web font document, in accordance with various embodiments of the present invention. In one embodiment, the steps included in the box 44 may be carried out in a particular application (or software module) included in the Web font server 42.

For the first array from the list (for the “Post Bold” font face array in the above example), in step 52, the first character code is retrieved, which is “A578” in the present example. In step 53, it is determined whether the character code belongs to any standard character code set and also whether the font face (i.e., the “Post Bold” font face in this example) is supported by the Web font server 42. If the answer is yes, proceeding to step 54, the Web font server 42 retrieves the Web font data corresponding to the received font data (of the first character) from the Web font database 43. Specifically, as described above, the Web font data define the Web font face name, character code, and also the URL address of the Web font face for the character. In step 57, using the retrieved Web font data, the Web font server 42 creates a HTML file that defines the first character in the received Asian Web page document using the Web font data. The HTML file created at this point may appear like the file of FIG. 3C, including only the first Chinese character 10 of the Asian language Web page 32. This process is repeated for all of the characters within the array (i.e., all the characters having the same font face) and also for all of the arrays (i.e., all the font faces used in the received Asian Web page document). Finally, at step 58, the Web font server 42 sends the constructed Asian font document in a HTML file to the Web server that initially sent the Asian Web page document to the Web font server 42, to replace the Asian Web page document with the constructed Asian font document at the Web server.

At step 53, if it is determined either that the character code does not belong to a standard code set or that the type face is not recognized by the Web font server 42, then at step 46 the Web font server 42 requests the non-standard Web font server 46 to send a Web font character (or Web font data) corresponding to the received character (in the Asian Web page document) to the Web font server 42. In this case, the Web font server 42 becomes a client of the non-standard Web font server 46.

In step 55, the non-standard Web font server 46 searches for Web font data corresponding to the received character in the non-standard Web font database 47. Specifically, based on the font data (e.g., the character code and font face name) of the received character, the non-standard Web font server 46 looks for any Web font data (including a character code, Web font face name, and the URL address of the Web font face) that match the received font data. If such Web font data are found, then the non-standard Web font server 46 returns the Web font data to the Web font server 42, and the Web font server 42 incorporates the received Web font data into the Web font document that it is constructing. Some exemplary methods and systems for the Web font server 42 to access and retrieve necessary font data from the non-standard Web server 46 are disclosed in U.S. Pat. No. 6,603,478, which is explicitly incorporated by reference herein.

Still in step 55, if the non-standard Web font server 46 cannot find corresponding Web font data for the received character, then the non-standard Web font server 46 sends a request to the Web font design center computer 49 to create Web font data corresponding to the received character. For example, the non-standard Web font server 46 sends a request, together with an image of the received character, or perhaps some values defining the geometric or morphological characteristics of the received character, to the Web font design center computer 49. Then, the Web font design center computer 9, either automatically or semi-automatically (i.e., with some input from a user), creates a Web font character (or Web font data) for the received character. To this end, a suitable character generation/definition software tool is installed in the Web font design center computer 9. In various exemplary embodiments of the present invention, the Web font character may be defined using a glyph-based or stroke-based method, many examples of which are disclosed in U.S. Pat. Nos. 5,852,448, 6,151,032, 6,157,390, and 6,501,475, which are all incorporated by reference herein. A Web font character may be defined using any other method, such as an outline-based method as known in the art.

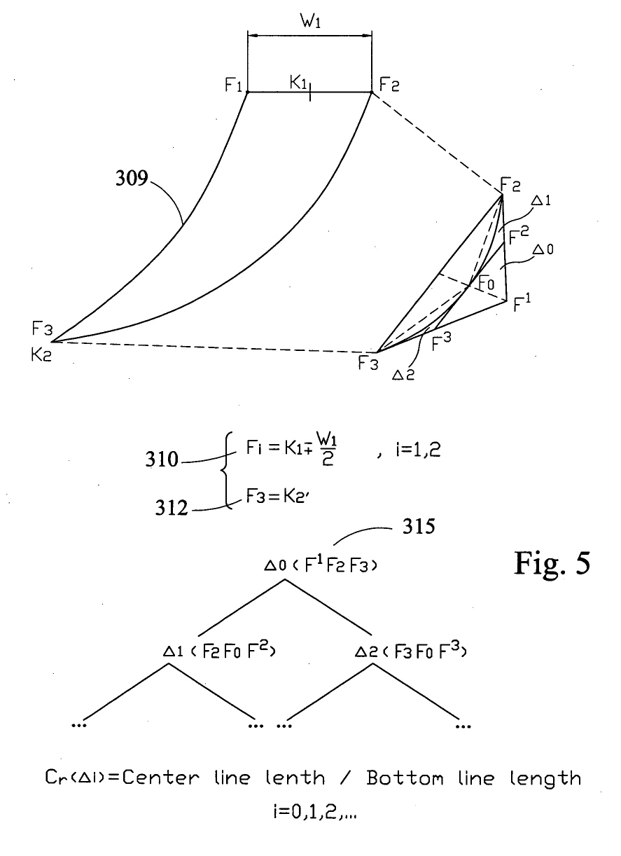

FIG. 5 illustrates various concepts used in a glyph-based or stroke-based method for defining a Web font character based on a received image of a character. As illustrated, any stroke (or glyph) 309 that forms part of a character may be defined in terms of function ƒ(K,W,F,Cr), where K denotes a “key point” (K₁ and K₂ are shown), W denotes a “width value” (W₁ is shown), F denotes a “feature point” (F₁, F₂, and F₃ are shown), and Cr denotes a “curve ratio” (Δ0(F¹F₂F₃), Δ1(F₂F₀F²), and Δ2(F₃F₀F³) are shown). The key points and width values are explicit parameters that are used to define the shape of a stroke (or glyph). The feature points and curve ratios are implicit parameters that can be derived from the explicit parameters. For example, in the illustrated example of FIG. 5, feature points F₁ and F₃ can be calculated based on the equations 310 and 312, respectively, by plugging the key points (K₁ and K₂) and width value (W₁) into the equations. Further, once the positions of the feature points are determined in this manner, then the curve between each adjacent pair of the feature points can be determined using the curve ratios arranged in a tree structure (see 315).

Specifically, the tree structure 315 defines the curve ratios between feature points F₂ and F₃ according to multiple levels of resolution. For example, Δ0(F₁F₂F₃) represents a Bezier triangle with a base of F₂F₃ and a vertex of F¹, and the curve ratio Cr is defined as the ratio between the center line length (i.e., the length of the line connecting the vertex and the middle point of the base of the Bezier triangle) and the length of the base. Δ1(F₂F₀F²) similarly defines the curve ratio between F₂ and F₀, and Δ2(F₃F₀F³) similarly defines the curve ratio between F₃ and F₀, to together define the curve between feature points F₂ and F₃ at a higher level of resolution.

Thus, a Web font character may be defined in terms of the explicit parameters (key points and width values) and the implicit parameters (feature points and curve ratios), and generally may be represented as function ƒ(K,W,F,Cr). As long as a client computer or a browser program operating thereon includes or can access a software program for rendering a character defined as such function, the client computer can readily display Web font characters defined in this manner.

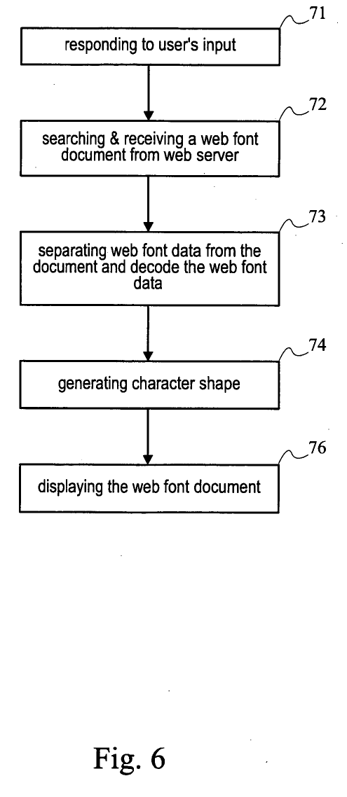

FIG. 6 is flowchart illustrating exemplary steps to be performed by a browser operating on a client computer for accessing and displaying Asian Web font documents, according to one embodiment of the present invention. At step 71, the browser responds to the user's request to retrieve a particular Web font document from a Web server (i.e., from a particular URL). In step 72, the browser searches and retrieves the requested Web font document from the Web server. In step 73, the browser separates Web font data (comprising the Web font face name, the location of the Web font face, and the character code for each character) from the received Web font document. In step 74, the browser generates a character shape for each character based on the Web font data. For example, if the Web font is defined as function ƒ(K,W,F,Cr), as discussed above, the browser constructs the shape of the character by decoding the function. To this end, a software program for decoding such function is installed (as plug-in software) in the client computer or may be downloaded from the Web font server 42. In step 76, the browser displays the Web font document, including Web font characters that appear the same as the original characters defined by the author of the original Web page document.

While the preferred embodiments of the invention have been illustrated and described, numerous variations in the illustrated and described arrangements of systems, components, and sequences of operations will be apparent to one skilled in the art based on this disclosure. Various aspects of the invention may be used separately, or in combinations, or in sequences other than those explicitly disclosed. Thus, it will be appreciated that various changes can be made therein without departing from the spirit and scope of the invention.

1. A network-based method of constructing a Web font document based on an Asian Web page document received from a Web server, the method comprising the steps of:
(a) receiving an Asian Web page document in a HTML file from a Web server;
(b) extracting font data from the received Asian Web page document, wherein the font data comprise a character code and a name of a font face for each character included in the Asian Web page document;
(c) replacing each character in the received Asian Web page document with a Web font character, wherein the Web font character is defined by a character code, a name of a Web font face, and a Uniform Resource Locator (URL) of the Web font face on a network;
(d) creating a Web font document in a HTML file; and
(e) sending the created Web font document to the Web server to replace the Asian Web page document at the Web server with the created Web font document.

2. The network-based method of claim 1, wherein the Web font document in a HTML file comprises a header portion and a body portion, the header portion includes the name of a Web font face and the URL of the Web font face for each character, and the body portion includes the character code for each character.

3. The network-based method of claim 1, wherein step (c) comprises replacing a character in the received Asian Web page document with a predefined Web font character that is stored in a database.

4. The network-based method of claim 3, wherein the predefined Web font character to replace the character in the received Asian Web page document is found based on a character code and a name of a font face of the character to be replaced in the received Asian Web page document.

5. The network-based method of claim 1, wherein step (c) further comprises:
(i) to replace a character in the received Asian Web page document, searching a database for a predefined Web font character that shares the same character code and name of a font face as the character to be replaced in the received Asian Web page document;
(ii) if no corresponding Web font character is found in the database in sub-step (i) above, generating a new Web font character based on an image of the character to be replaced in the received Asian Web page document; and
(iii) replacing the character in the received Asian Web page document with the new Web font character generated in sub-step (ii) above.

6. A network-based system for constructing a Web font document based on an Asian Web page document supported by a Web server, the system comprising:
(a) a Web server connected to a network, the Web server supporting an Asian Web page document;
(b) a Web font server connected to the network for constructing a Web font document based on an Asian Web page document received from a Web server, the Web font server comprising a Web font database including standard Web font characters; and
(c) a non-standard Web font server connected to the network, the non-standard Web font server comprising a non-standard Web font database including non-standard Web font characters;
wherein the Web font server further comprises:
(i) means for receiving an Asian Web page document in a HTML file from a Web server;
(ii) means for extracting font data from the received Asian Web page document, wherein the font data comprise a character code and a name of a font face for each character included in the Asian Web page document;
(iii) means for replacing each character in the received Asian Web page document with a Web font character, wherein the Web font character is defined by a character code, a name of a Web font face, and a Uniform Resource Locator (URL) of the Web font face on a network;
(iv) means for creating a Web font document in a HTML file; and
(v) means for sending the created Web font document to the Web server to replace the Asian Web page document at the Web server with the created Web font document.

7. The network-based system of claim 6, wherein the Web font document in a HTML file comprises a header portion and a body portion, the header portion includes the name of a Web font face and the URL of the Web font face for each character, and the body portion includes the character code for each character.

8. The network-based system of claim 6, wherein the means for replacing each character in the received Asian Web page document with a Web font character further comprise:
means for searching the Web font database for a predefined Web font character that shares the same character code and name of a font face as the character to be replaced in the received Asian Web page document; and
means for searching the non-standard Web font database for a predefined Web font character that shares the same character code and name of a font face as the character to be replaced in the received Asian Web page document.

9. The network-based system of claim 6, wherein the means for replacing each character in the received Asian Web page document with a Web font character further comprise means for instructing the non-standard Web font server to generate a new Web font character based on an image of the character to be replaced in the received Asian Web page document.

10. The network-based system of claim 9, wherein the non-standard Web font server further comprises a Web font character designing system that is configured to generate a new Web font character based on an image of the character to be replaced in the received Asian Web page document, and the new Web font character generated by the Web font character designing system is stored in the non-standard Web font database.

11. A method of defining Web font characters for replacing characters included in an Asian Web page document, the method comprising the steps of:
(a) defining standard Web font characters, comprising the sub-steps of:
(i) designating a font face name to a set of standard Asian characters, each associated with a standard character code;
(ii) defining the set of standard Asian characters as standard Web font characters based on their font face name as designated in sub-step (i), standard character codes, and a Uniform Resource Locator (URL) of the Web font face; and
(iii) storing the standard Web font characters in a file in a database; and
(b) defining non-standard Web font characters, comprising the sub-steps of:
(i) receiving an image of a character to be defined as a non-standard Web font character;
(ii) generating a non-standard Web font character based on the received image of the character;
(iii) assigning a font face name and a character code to the non-standard Web font character generated in sub-step (ii) above;
(iv) defining the non-standard Web font character in terms of its Web font face name, character code, and a URL of the Web font face; and
(v) storing the non-standard Web font character in a file in a database.

12. The method of claim 11, wherein step (b)(ii) further comprises:
defining explicit parameters comprising key points and width values that describe a shape of the received image of the character; and
defining implicit parameters comprising feature points and curve ratios that describe the shape of the received image of the character based on the explicit parameters.

13. A computer-readable tangible medium comprising a computer-executable browser program for browsing Asian Web font documents, the browser program comprising:
means for receiving a user request to view an Asian Web font document at a particular Uniform Resource Locator (URL);
means for receiving an Asian Web font document from a Web server corresponding to the particular URL, the Asian Web font document being in a HTML file comprising a header portion and a body portion, the header portion including the name of a Web font face and the URL of the Web font face for each Web font character included in the Asian Web font document, and the body portion including the character code for each Web font character;
means for decoding the received HTML file to identify the name of a Web font face, the URL of the Web font face, and the character code for each Web font character included in the Asian Web font document; and
means for displaying the Asian Web font document by rendering each Web font character according to the corresponding name of a Web font face, the URL of the Web font face, and the character code.

14. The computer-readable tangible medium of claim 13, wherein at least one Web font character included in the Asian Web font document is defined by explicit parameters comprising key points and width values and implicit parameters comprising feature points and curve ratios, and the means for displaying the Asian Web font document render the at least one Web font character by:
calculating the locations of the feature points based on the key points and width values; and
generating curves between each adjacent pair of the feature points based on the curve ratios.

15. A computer-readable tangible medium comprising computer-executable instructions which, when loaded onto a Web font server, cause the Web font server to perform the steps of:
(a) receiving an Asian Web page document in a HTML file from a Web server;
(b) extracting font data from the received Asian Web page document, wherein the font data comprise a character code and a name of a font face for each character included in the Asian Web page document;
(c) replacing each character in the received Asian Web page document with a Web font character, wherein the Web font character is defined by a character code, a name of a Web font face, and a Uniform Resource Locator (URL) of the Web font face on a network;
(d) creating a Web font document in a HTML file; and
(e) sending the created Web font document to the Web server to replace the Asian Web page document at the Web server with the created Web font document.

16. The computer-readable tangible medium of claim 15, wherein the Web font document in a HTML file comprises a header portion and a body portion, the header portion includes the name of a Web font face and the URL of the Web font face for each character, and the body portion includes the character code for each character.

17. The computer-readable tangible medium of claim 15, wherein step (c) comprises replacing a character in the received Asian Web page document with a predefined Web font character that is stored in a database.

18. The computer-readable tangible medium of claim 17, wherein the predefined Web font character to replace the character in the received Asian Web page document is found based on a character code and a name of a font face of the character to be replaced in the received Asian Web page document.

19. The computer-readable tangible medium of claim 15, wherein step (c) further comprises:
(i) to replace a character in the received Asian Web page document, searching a database for a predefined Web font character that shares the same character code and name of a font face as the character to be replaced in the received Asian Web page document;
(ii) if no corresponding Web font character is found in the database in sub-step (i) above, generating a new Web font character based on an image of the character to be replaced in the received Asian Web page document; and
(iii) replacing the character in the received Asian Web page document with the new Web font character generated in sub-step (ii) above.
